(19) United States
(12) Patent Application Publication
(10) Pub. No.: US 2026/0151769 A1
(43) Pub. Date: Jun. 4, 2026

(54) CHIP LAB CARTRIDGE WITH MAGNETIC PARTICLES AND METHOD FOR PURIFICATION METHODS WITH SUCH A CHIP LAB CARTRIDGE

(71) Applicant: Robert Bosch GmbH, Stuttgart (DE)

(72) Inventor: Ingo Ramsteiner, Ettlingen (DE)

(21) Appl. No.: 19/310,045

(22) Filed: Aug. 26, 2025

(30) Foreign Application Priority Data
Aug. 27, 2024 (DE) 10 2024 208 131.0

(51) Int. Cl. B01L 3/00

(52) U.S. Cl. CPC B01L 3/502753; B01L 3/502715; B01L 2300/047; B01L 2300/0681; B01L 2300/0848; B01L 2300/0861; B01L 2300/123; B01L 2300/14; B01L 2400/0487

(57) ABSTRACT

A chip lab cartridge, preferably for single use, in particular for a modular medical analysis system, has a layer structure with a pneumatic layer and a fluidic layer, which are arranged in layers in an extension plane and are separated by an elastic membrane. The pneumatic layer and the fluidic layer form a first cavity, which is formed in a first part in the pneumatic layer and in a second part in the fluidic layer. A first sample chamber is bounded by the elastic membrane and is formed in the first cavity, which is connected in a fluid-conducting manner to a first fluid channel and a second fluid channel formed in the fluidic layer. A liquid is introduced into the first sample chamber by the first fluid channel and/or the second fluid channel.

This application claims priority under 35 U.S.C. § 119 to patent application no. DE 10 2024 208 131.0, filed on Aug. 27, 2024 in Germany, the disclosure of which is incorporated herein by reference in its entirety.

The disclosure relates to a single-use chip lab cartridge for use in an analysis device and a method for operating a chip lab cartridge.

### BACKGROUND

Chip lab cartridges are known and established. Furthermore, the use of magnetic particles, also referred to as “beads”, for the purification of samples is well established for various laboratory work. The basic idea is for magnetic particles to be suspended, wherein they are functionalized at their surface to bind specific target molecules, for example proteins, from the surrounding liquid. The magnetic particles can be fixed in place by bringing a permanent magnet close to the vessel wall or switching on an electromagnet. The liquid may be exchanged while the magnetic particles remain with the molecules in the vessel. Once the liquid has been replaced, the magnetic particles may be suspended again by removing and/or turning off the magnetic field. By adding an elution buffer liquid, the molecules are can be detached from the magnetic particles again. The magnetic particles can be magnetically fixed again and the solution that is now purified can be removed. In order to perform this procedure, specific laboratory technology is necessary, making the procedure more expensive and complex. Laboratory systems for use with a chip lab cartridge are also known to enable such a method of purification. DE 10 2019 200 108 A1 discloses such a laboratory system, wherein the analysis device comprises excitation means, in particular for generating a magnetic field. The appropriate chip lab cartridges need to be specific to the analysis device so that the laboratory system is inflexible with respect to the design of the chip lab cartridge, particularly with respect to changes after the analysis device is defined.

The object of the disclosure, in light of this, is to propose a chip laboratory cartridge that provides a simple and cost-efficient way to perform methods with magnetic particles for sample purification, particularly in a modular, medical analysis system as is known for use with chip laboratory cartridges. A flexible solution should be proposed in this context.

### SUMMARY

The chip laboratory cartridge according to the disclosure, the system for performing an analysis and the method for operating a chip laboratory cartridge have the advantage that a particularly simple and user-friendly option for using magnetic particles for sample purification is possible. In particular, existing laboratory infrastructure in the form of a modular medical analysis system can be used. A known laboratory system can be expanded with additional functionality at low cost. Advantageously, the chip laboratory cartridge according to the disclosure can be used without changes to the hardware of a modular medical analysis system.

The chip lab cartridge, preferably for single use, in particular for a modular medical analysis system, has a layer structure having a pneumatic layer and a fluidic layer, which are arranged in layers in particular in an extension plane, and separated by an elastic membrane, wherein the pneumatic layer and the fluidic layer form a first cavity, which is formed in a first part in the pneumatic layer and in a second part in the fluidic layer. In the first cavity, a first sample chamber bounded by the elastic membrane is formed and connected in a fluid-conducting manner to a first fluid channel and to a second fluid channel formed in the fluidic layer. The pneumatic layer comprises a pneumatic channel by means of which the first part of the first cavity can be pressurized with a vacuum or overpressure such that the elastic membrane is variably displaceable in the cavity so that the volume of the first sample chamber is variably adjustable between a minimum volume and a maximum volume. The minimum volume and the maximum volume are dependent on the elastic membrane, in particular on its deformability. The minimum volume is given while the elastic membrane is displaced in the direction of the second part of the first cavity. The maximum volume is given while the elastic membrane is displaced in the direction of the second part of the first cavity. A noticeable volume difference between the minimum volume and the maximum volume must be given. Preferably, the minimum volume of the first sample chamber is given while the elastic membrane is displaced to abut against the wall of the second part of the first cavity. The volume of the first sample chamber is as low as possible and can be assumed to be approximately 0. Preferably, the maximum volume of the first sample chamber is given while the elastic membrane is displaced to abut against the wall of the first part of the first cavity. The volume of the first sample chamber corresponds approximately to the total volume of the first cavity.

According to the disclosure, it is provided that a magnetic field generating means is arranged in the chip laboratory cartridge, whose magnetic field acts in the first cavity and whose magnetic field strength is determined depending on magnetic particles, which can be introduced into the first sample chamber of the chip laboratory cartridge via the first fluid channel and/or the second fluid channel or are contained in the first sample chamber, such that the magnetic particles can be magnetically fixed once a specific deformability and/or a fastening limit deformation of the elastic membrane in the region of the first part of the first cavity is exceeded, and that the magnetic fixation can be released by moving the elastic membrane in the direction of the second part of the first cavity once a second specific deformability and/or release limit deformation of the elastic membrane is undershot. The magnetic particles may be contained in the chip laboratory cartridge and preferably be present in a storage suspension therein, or they may be introduced into the chip laboratory cartridge only when it is to be used. They have paramagnetic or ferromagnetic properties. They can be magnetically fixed in the first sample chamber of the chip lab cartridge, wherein the magnetic fixation is removable so that the magnetic particles can be flexibly introduced into the first sample chamber, fixed therein, and removed from the first sample chamber.

Advantageous further developments of the chip laboratory cartridge according to the disclosure and the method according to the disclosure for operating a chip laboratory cartridge are provided herein.

In a first preferred embodiment of the chip lab cartridge, the magnetic field generating means may comprise a permanent magnet, in particular from an NdFeB alloy, which in particular has a volume of between 0.3 and 8 mm³, preferably between 1 and 5 mm³. A permanent magnet can be used to generate a magnetic field with a constant or unchanging magnetic field strength at a specific point in space. The magnetic field strength changes as the permanent magnet is moved closer to or further away from the point. In operation, a permanent magnet advantageously does not require any control and/or power supply. The chip laboratory cartridge can thus be designed particularly simple and reliable. A permanent magnet from an NdFeB alloy may produce an advantageously strong magnetic field. The volume and thus the magnetic field strength of the permanent magnet can be adapted to the particular application of the chip laboratory cartridge. For common applications and in the area of common membrane deformations, permanent magnets in the above-mentioned volume range are shown to be particularly advantageous.

In an alternative embodiment to the above-mentioned embodiment of the chip laboratory cartridge, the magnetic field-generating means may comprise an electromagnet with which a magnetic field of variable magnetic field strength can be generated, in particular at a fixed point in space. By means of an electromagnet, the magnetic field-generating means can advantageously be flexible. The magnetic field strength of an electromagnet is simple in operation and variable without hardware-side changes, wherein only the control of the electromagnet is to be changed. Advantageously, a magnetic field-generating means of the same design can be used for different applications of the chip laboratory cartridge. Furthermore, by means of an electromagnet, subsequent changes in the field line density and/or the magnetic field strength are possible and it is possible to adjust the magnetic field strength in operation of the chip laboratory cartridge and/or to perform an operation with a variable magnetic field strength. This may advantageously enable the targeted dissolution of the magnetic fixation of magnetic particles and further advantageously also allow different magnetic particles to be used with different magnetic properties.

In a further preferred embodiment of the chip lab cartridge, the fluidic layer can be arranged above the pneumatic layer, wherein the magnetic field of the magnetic field generating means acts in the first cavity such that magnetic particles suspended in the first sample chamber can sink under the influence of gravity in the direction of the first part of the first cavity into an area of action of the magnetic field of the magnetic field generating means. In addition to the diffusion and Brownian motion of the magnetic particles in the first sample chamber, by means of which they are moved towards the area of action of the magnetic field-generating means, gravity also contributes advantageously to the magnetic particles reaching the effective range of the magnetic field of the magnetic field generator and being fixable by this magnetic field. For example, the chip lab cartridge may specify the arrangement of the fluidic layer above the pneumatic layer during use by means of a preferred direction. Advantageously, the fixation of the magnetic particles can be accelerated and a higher proportion of fixed magnetic particles can be achieved. The area of effect of the magnetic field generating means is to be understood as the area in which the magnetic field acts so strongly that the magnetic particles are magnetically fixed.

In a next preferred embodiment, the chip lab cartridge may be configured in the chip lab cartridge, a second cavity having a second sample chamber and a third cavity having a third sample chamber are formed, wherein the first sample chamber is connected in a fluid-conducting manner to the second sample chamber by means of the first fluid channel and to the third sample chamber by means of the second fluid channel, such that a fluidly connected series circuit from the first, second and third sample chambers, wherein a sample supply line is connected in a fluid-conducting manner to the second sample chamber and a sample discharge line is fluidly connected to the third sample chamber, wherein a liquid can be introduced into the second sample chamber by means of the sample supply line and can be transferred into the first sample chamber and further into the third sample chamber. The first part of the first cavity is pneumatically connected to a first pneumatic channel, which acts on the elastic membrane, the first part of the second cavity is pneumatically connected to a second pneumatic channel, which acts on a second elastic membrane, and the first part of the third cavity is pneumatically connected to a third pneumatic channel, which acts on a third elastic membrane, so that a suction and/or pressure effect can be generated in the first sample chamber by displacing the elastic membranes, which causes the liquid to be transferred.

Preferably, the first elastic membrane, the second elastic membrane and the third elastic membrane may be comprised of a continuous monolithic membrane body, which may then also advantageously extend through the pneumatic channels along which the membrane body is fixed or immovable.

In a further preferred embodiment of the chip laboratory cartridge, a fluidly conductive connection between the first sample chamber and a reservoir for elution buffer fluid may be provided in the fluidic layer, so that an elution buffer fluid can be introduced into the first sample chamber, whereby the target molecules can be detached from the magnetic particles and transferred into solution.

In a next preferred embodiment of the chip laboratory cartridge, a fluidly conductive connection of the first sample chamber to a reservoir of wash buffer liquid may be provided such that a wash buffer liquid can flow through the first sample chamber, wherein contaminants and/or other substances and/or particles to be removed can be separated from the magnetically fixed magnetic particles.

Furthermore, a system for performing an analysis of the disclosure is also included. It comprises at least one reaction mixture and a chip laboratory cartridge according to the disclosure having an inlet for the reaction mixture. According to the disclosure, it is provided that the magnetic particles in the chip laboratory cartridge are upstream of surrounded by the reaction mixture in a sample chamber, preferably in the first sample chamber, which is connected in a fluid-conducting manner to the inlet for the reaction mixture. To avoid unnecessary repetition, reference is made to the advantages and advantageous embodiments discussed above. All embodiments disclosed in relation to the chip lab cartridge and in relation to the method of operating a chip lab cartridge are also to be considered disclosed and claimable for the system.

Furthermore, a method for operating a chip lab cartridge, preferably for single use, which is particularly used in a modular medical analysis system, is also comprised by the disclosure. The chip lab cartridge has a layer construction with a pneumatic layer and a fluidic layer, which is arranged in layers in an extension plane and separated by an elastic membrane. The pneumatic layer and the fluidic layer form a first cavity, which is formed in a first part in the pneumatic layer and a second part in the fluidic layer. In the first cavity, a first sample chamber bounded by the elastic membrane is formed and connected in a fluid-conducting manner to a first fluid channel and to a second fluid channel formed in the fluidic layer. A liquid is introduced into the first sample chamber by means of the first fluid channel and/or the second fluid channel, wherein the pneumatic layer has a pneumatic channel by means of which the first part of the first cavity is exposed to a vacuum or positive pressure, such that the elastic membrane is variably displaced in the first cavity so that the volume of the first sample chamber is variably adjusted between a minimum volume and maximum volume. By purposefully displacing the elastic membrane, i.e. by changing the volume of the first sample chamber, it is possible to draw liquids into the first sample chamber and push them out of the first sample chamber. It is further possible to allow or block a liquid from flowing through the first sample chamber. The first sample chamber can thus act as a pump and as a valve by suitable displacing the elastic membrane. The indication of a positive pressure or a negative pressure for displacement of the membrane refers to the relative pressure difference between the first part of the first cavity and the first sample chamber and the fluid channels connected in a fluid-conducting manner to the first sample chamber. An ambient pressure can also be a relatively lower pressure, i.e. a negative pressure. In particular, the liquid may be a sample liquid in which magnetic particles and/or target molecules and/or impurities are suspended and/or dissolved, a wash buffer liquid or an elution buffer liquid.

According to the disclosure, it is provided that magnetic particles are magnetically fixed once a fastening limit deformation of the membrane in the region of the first part of the first cavity is exceeded and that the magnetic fixation of the magnetic particles is released by moving the elastic membrane in the direction of the second part of the first cavity once a release limit deformation of the membrane is undershot. In the chip lab cartridge, a magnetic field generating means is arranged, whose magnetic field acts in the first cavity and whose magnetic field strength is dependent on magnetic particles, which are introduced into the first sample chamber of the chip lab cartridge via the first fluid channel or the second fluid channel, or are contained in the first sample chamber and the fastening limit deformation and the solution limit deformation is defined.

Advantageously, magnetic fixation is thus particularly easily possible, in particular without an additional magnetic field generating means not comprised by the chip lab cartridge. It is possible to supply the magnetic particles from outside the chip lab cartridge, for example mixed with a sample liquid, to the chip lab cartridge or to keep them in the chip lab cartridge. If they are stored in the chip laboratory cartridge, it is advantageous to keep the magnetic particles in a storage suspension and separate the magnetic particles from the storage suspension prior to performance.

For simplicity, reference is made to the effects disclosed in the apparatus with respect to further advantageous effects of the method.

In a first preferred embodiment of the method of operating a chip lab cartridge, the magnetic particles and target molecules may be purposefully attached to one another and dislodged from one another, the magnetic particles having chemical structures by which the target molecules reversibly adhere to the magnetic particles. Advantageously, the target molecules are attached particularly simply and sufficiently securely to the magnetic particles and are purposefully detached. By selectively selecting the chemical structures for adhesion of the target molecules, the magnetic particles are advantageously adaptable to different target molecules. Adhesion can be based on various chemical and/or physical principles of action.

In a further preferred embodiment of the method for operating a chip lab cartridge, a liquid may be introduced into a second sample chamber by way of a sample supply line and transferred into the first sample chamber and further into the third sample chamber. In the chip lab cartridge, a second cavity having a second sample chamber and a third cavity having a third sample chamber are formed, wherein the first sample chamber is connected in a fluid-conducting manner to the second sample chamber by means of the first fluid channel and to the third sample chamber by means of the second fluid channel, such that a fluidly connected series circuit is formed from the first, second, and third sample chambers. The sample supply line is connected in a fluid-conducting manner to the second sample chamber and a sample discharge line to the third sample chamber. The first part of the first cavity is pneumatically connected to a first pneumatic channel, which acts on the elastic membrane, the first part of the second cavity is pneumatically connected to a second pneumatic channel, which acts on a second elastic membrane, and the first part of the third cavity is pneumatically connected to a third pneumatic channel, which acts on a third elastic membrane, so that a suction and/or pressure effect can be generated in the first sample chamber by displacing the elastic membranes, which causes the liquid to be transferred. As described above with respect to the first sample chamber, the second and third sample chambers may also act as a pump and as a valve.

In a next preferred embodiment of the method for operating a chip lab cartridge, a magnetic field with a temporally invariant magnetic field strength can be generated, wherein the magnetic field generating means comprises a permanent magnet, in particular from an NdFeB alloy, which in particular comprises a volume of between 0.3 and 8 mm³, preferably between 1 and 5 mm³.

In an alternative embodiment of the method for operating a chip laboratory cartridge, a generation of a magnetic field with temporally varying magnetic field strength can be provided, wherein the magnetic field generating means comprises an electromagnet.

In a next preferred embodiment of the method for operating a chip lab cartridge, a gravity-induced sinking of magnetic particles located in suspension in the first sample chamber towards the first part of the first cavity into an area of action of the magnetic field generating means can be provided, wherein the fluidic layer is disposed above the pneumatic layer.

In a further preferred embodiment of the method of operating a chip lab cartridge, the elastic membrane may be displaced such that the sample chamber occupies a predominant part of the first part of the first cavity and is passed through with a liquid, preferably with a wash buffer liquid, by means of the fluid channels, wherein the magnetic particles remain fixed in the first sample chamber. The strength of the magnetic field can be determined by selecting a permanent magnet in the manufacture of the chip lab cartridge or when using an electromagnet during operation of the chip lab cartridge. Advantageously, it allows for sufficient magnetic fixation of the magnetic particles so that contaminants and/or other substances to be removed and/or particles can be separated from the magnetic particles by passing through the first sample chamber with a liquid. The sufficiently powerful magnetic fixation of the magnetic particles ensures that the magnetic particles remain in the first sample chamber, wherein target molecules adhered to the magnetic particles also remain in the first sample chamber. Thus, the targeted rinsing and/or retention of molecules in the first sample chamber can be advantageously achieved in a targeted manner. A wash buffer liquid advantageously allows for removal of impurities, with the target molecules remaining unaffected.

In a next preferred embodiment of the method for operating a chip lab cartridge, an introduction of an elution buffer liquid into the first sample chamber may be provided, wherein target molecules adhered to the magnetic particles are detached from the magnetic particles and transferred into solution. A coordinated selection of magnetic particles and elution buffer liquid as a function of the target molecules allows the target molecules to be detached from the magnetic particles, which advantageously allows further processing of the target molecules without adhering magnetic particles. Furthermore, the magnetic particles can thus be supplied to a subsequent method carried out according to the disclosure.

In an advantageous furtherance thereof, discharge of the elution buffer liquid with the target molecules dissolved therein from the first sample chamber may be provided, wherein the magnetic particles remain in the first sample chamber. This is possible, for example, by introducing an additional liquid into the first sample chamber, thereby displacing the elution buffer liquid with the target molecules dissolved therein from the first sample chamber. It is thus advantageously possible to separate the target molecules from the magnetic particles. Further, downstream processing, for example an analysis, of the target molecules may be performed at a location other than the sample chamber.

In a further preferred embodiment of the method for operating a chip lab cartridge, a pressurization of the first part of the first cavity with positive pressure by means of the first pneumatic channel can be provided, wherein the elastic membrane is displaced in the first cavity such that by displacing the elastic membrane, the magnetic particles are moved out of the magnetic field of the magnetic field generating means, wherein the magnetic fixation is lifted. It is thus advantageously possible to remove the magnetic particles from the first sample chamber in accordance with the present requirements for carrying out the method. For example, it is possible to transfer the magnetic particles to a further sample chamber by means of the first fluid channel and to mix with a liquid, preferably a sample liquid or an elution buffer liquid.

The features described and claimed in the method shall also be considered disclosed in terms of device and be claimable, and vice versa.

Further advantages, features and details of the invention can be seen from the following description of preferred embodiments of the disclosure and from the drawings.

### BRIEF DESCRIPTION OF THE DRAWINGS

FIG. 1 shows a schematic illustration of an excerpt of a chip laboratory cartridge according to the invention,

FIG. 2A shows an excerpt of a chip laboratory cartridge in a schematic representation,

FIG. 2B shows an excerpt of a chip laboratory cartridge in a schematic representation,

FIG. 2C shows an excerpt of a chip laboratory cartridge in a schematic representation,

FIG. 2D shows an excerpt of a chip laboratory cartridge in a schematic representation,

FIG. 2E shows an excerpt of a chip laboratory cartridge in a schematic representation,

FIG. 2F shows an excerpt of a chip laboratory cartridge in a schematic representation,

FIG. 2G shows an excerpt of a chip laboratory cartridge in a schematic representation,

FIG. 2H shows an excerpt of a chip laboratory cartridge in a schematic representation, and

FIG. 2I shows an excerpt of a chip laboratory cartridge in a schematic representation.

### DETAILED DESCRIPTION

The same elements or elements having the same function are provided with the same reference numbers in the figures.

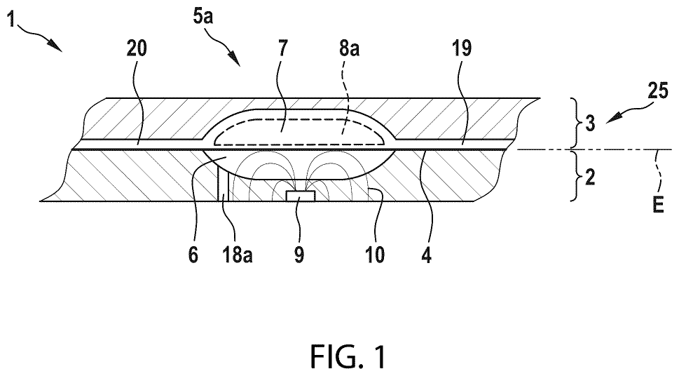

FIG. 1 shows an excerpt of a chip laboratory cartridge 1 according to the disclosure in a schematic representation. The chip lab cartridge 1 has a layer construction 25 comprising a pneumatic layer 2 and a fluidic layer 3. The fluidic layer 3 of the chip lab cartridge 1 lies above the pneumatic layer 2 of the chip lab cartridge 1. The two layers 2, 3 are coated in an extension plane E and are separated from an elastic membrane 4. A first cavity 5a is formed to a first part 6 in the pneumatic layer 2 and to a second part 7 in the fluidic layer 3. The elastic membrane 4 passes through this first cavity 5a. The elastic membrane 4 encloses a first sample chamber 8a in the fluidic layer 3 in the first cavity 5a. Depending on the position, i.e. how the elastic membrane 4 is displaced in the first cavity 5a, the first variable volume sample chamber Sa is formed. By means of the first pneumatic channel 18a, the first part 6 of the first cavity 5a can be exposed to a positive or negative pressure, thereby displacing the elastic membrane 4 in the first cavity 5a.

The first sample chamber 8a is connected in a fluid-conducting manner to a first fluid channel 19 and to a second fluid channel 20. A magnetic field generating means 9 is formed in the pneumatic layer 2 and is arranged on the first part 6 of the first cavity 5a such that the magnetic field 10 of the magnetic field-generating means 9 impacts the first part 6 of the first cavity 5a. It can already be seen from this that the magnetic field 10 has different strong effects in the first sample chamber 8a as a function of the displacement position of the elastic membrane 4. The strength of the magnetic field 10 is dependent on the distance to the magnetic field generating means 9, so that the magnetic field 10 acts more strongly in parts of the first sample chamber 8a, the further the elastic membrane 4 and consequently the limitation of the first sample chamber 8a towards the pneumatic layer 2 is displaced. In other words, the magnetic field 10 acts more strongly in the first part 6 of the first cavity 5a than in the second part 7, so that it also acts more strongly in the first sample chamber 8a when the elastic membrane 4 is displaced such that the first sample chamber 8a is also formed in the first part 6.

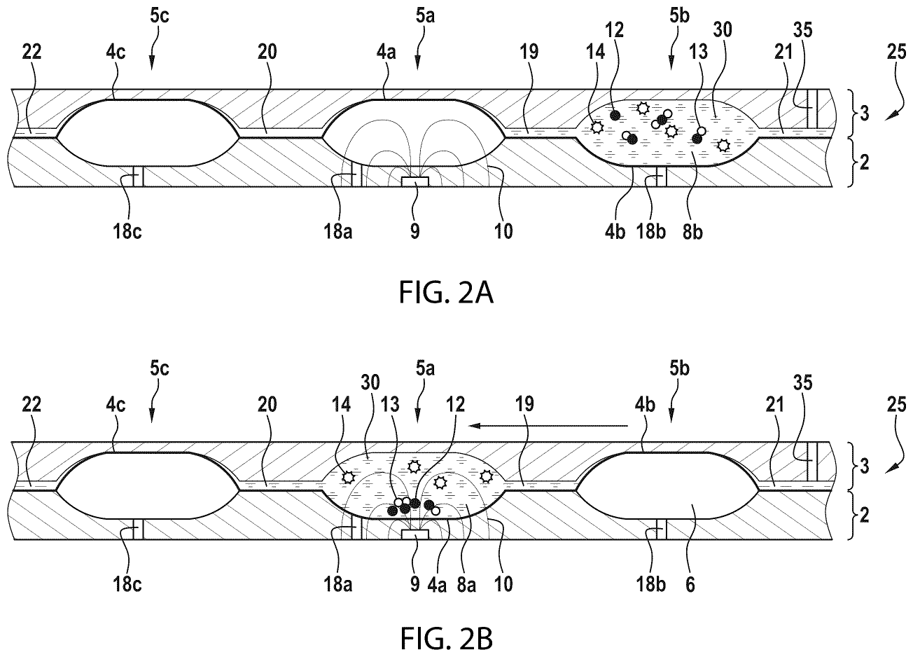

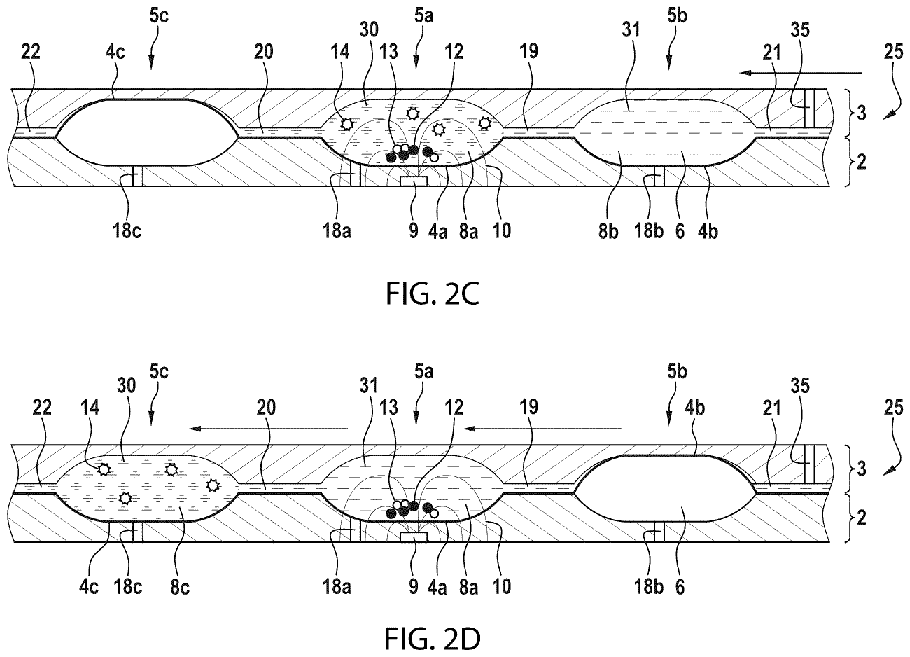

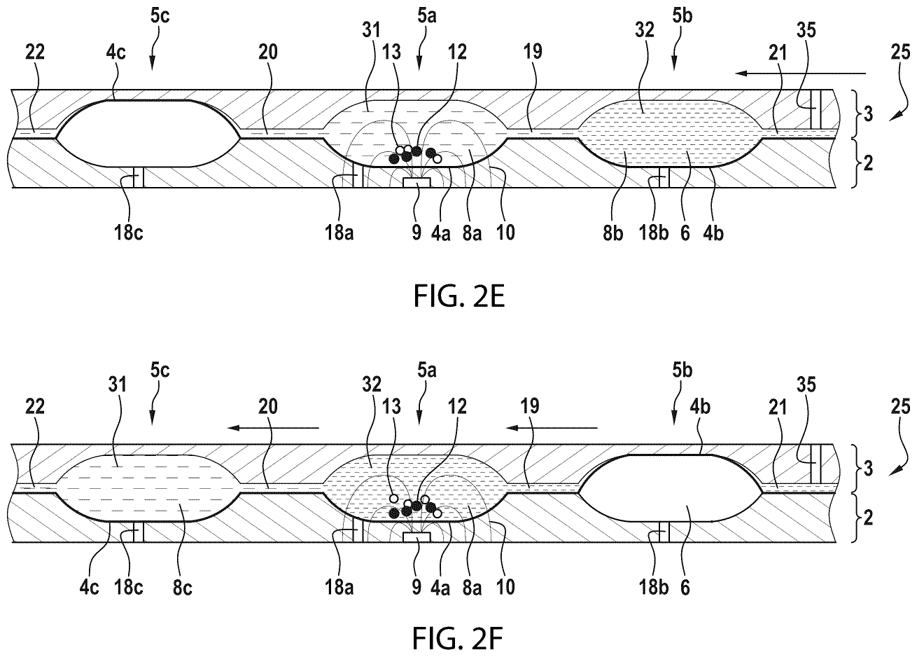

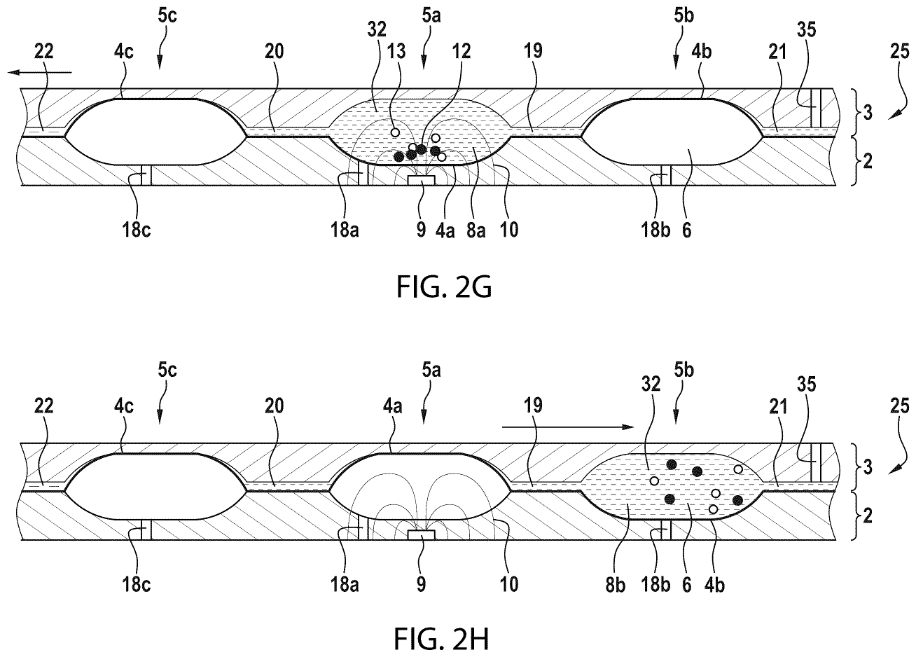

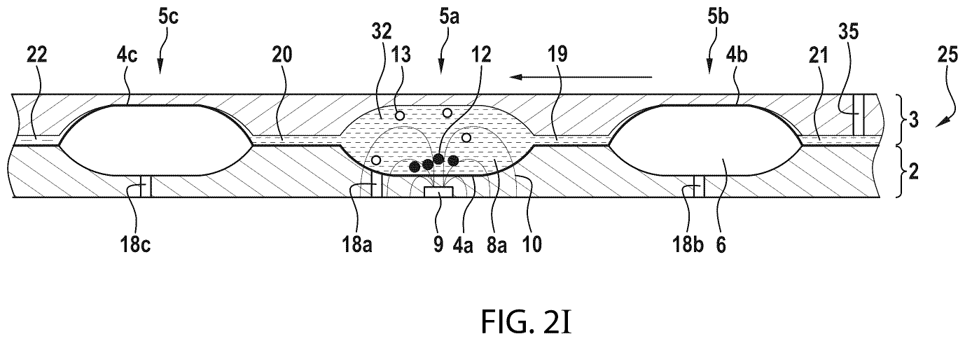

FIGS. 2A through 2I show several method steps of an exemplary method for operating a chip laboratory cartridge 1 according to the disclosure. Shown are a first cavity 5a having a first sample chamber 8a, a second cavity 5b having a second sample chamber 8b, and a third cavity 5c having a third sample chamber 8c. In this respect, the first cavity 5a corresponds to the embodiment described with reference to FIG. 1 with a magnetic field-generating means 9 and a magnetic field 10. The second cavity 5b and the third cavity 5c differ from the first cavity 5a by the absence of a magnetic field generating means 9. The sample chamber 8a of the first cavity 5a is connected in a fluid-conducting manner to the second sample chamber 8b by means of a first fluid channel 19 and to the third sample chamber 8c by means of a second fluid channel 20. The second sample chamber 8b is connected in a fluid-conducting manner to a sample supply line 21 and the third sample chamber 8c is connected in a fluid-conducting manner to a sample discharge line 22. An inlet for a reaction mixture 35 is connected in a fluid-conducting manner to the sample supply line 21. The first part 6 of the first cavity 5a is pneumatically connected to a first pneumatic channel 18a, the first part 6 of the second cavity 5b is pneumatically connected to a second pneumatic channel 18b, and the first part 6 of the third cavity 5c is pneumatically connected to a third pneumatic channel 18c.

FIG. 2A shows a starting state of a method for operating a chip laboratory cartridge 1 according to the disclosure. The elastic membrane 4 is displaced in the first cavity 5a such that the volume of the first sample chamber 8a is minimal, the elastic membrane 4 abuts the wall of the first cavity 5a in the fluidic layer 3 of the chip laboratory cartridge 1. The third elastic membrane 4c in the third cavity 5c is also displaced. The second elastic membrane 4b in the second cavity 5b is displaced in the opposite direction, so that the volume of the second sample chamber 8b is maximized. The second sample chamber 8b is filled with a sample liquid 30 containing contaminants 14, target molecules 13 and magnetic particles 12. the second sample chamber 8b is filled by means of the sample supply line 21 and the inlet for a reaction mixture 35 in a preceding method step. The magnetic particles 12 are chemically and/or physically arranged such that the target molecules 13 adhere to the magnetic particles 12.

FIG. 2B shows the chip lab cartridge 1 after a first method step. The sample liquid 30 with the particles 12, 13, 14 contained therein is transferred from the second sample chamber 8b to the first sample chamber 8a through the first fluid channel 19. This transfer is achieved by applying positive pressure to the first part 6 of the second cavity 5b by means of the second pneumatic channel 18b and the consequent displacing of the second resilient membrane 4b, whereby the volume of the second sample chamber 8b is minimally conveyed out of the second sample chamber 8b and the sample liquid 30 contained therein through the first fluid channel 19. The third elastic membrane 4c in the third cavity 5c is displaced unchanged by applying positive pressure to the first part of the third cavity by means of the third pneumatic channel 18c such that no liquid can flow into the third sample chamber 8c through the second fluid channel 20, the third sample chamber 8c acts as a closed valve. In the first cavity 5a, the magnetic field 10 of the magnetic field generating means 9. This magnetic field 10 fixes the magnetic particles 12 and thus also the target molecules 13 adhered to the magnetic particles 12 in the first sample chamber 8a.

In a second method step shown in FIG. 2C, a wash buffer liquid 31, which does not contain contaminants 14, is sucked into the second sample chamber 8b by the sample supply line 21 by displacing the second elastic membrane 4b. To this end, the first part 6 of the second cavity 5b is exposed to a negative pressure by means of the second pneumatic channel 18b.

In the third method step, which is shown in FIG. 2D, this wash buffer liquid 31 is transferred to the first sample chamber 8a and the sample liquid 30 located therein is transferred from the first sample chamber 8a to the third sample chamber 8c with impurities 14 contained therein. To this end, the second elastic membrane 4b is displaced in the second cavity 5b and in the third elastic membrane 4c of the third cavity 5c in an opposite manner. To this end, the first part 6 of the second cavity 5b is exposed to a positive pressure by means of the second pneumatic channel 18b. In a method step not shown, the sample liquid 30 is displaced from the third sample chamber 8c by displacing the third resilient membrane 4c in the third cavity 5c and discharged out of the third sample chamber 8c by the sample discharge line 22.

In the next method steps shown in FIGS. 2E, 2F, and 2G, an elution buffer liquid 32 is introduced into the second sample chamber 8b through the sample supply line 21 and then transferred to the first sample chamber 8a, wherein the wash buffer liquid 31 located therein is transferred from the first sample chamber 8a to the third sample chamber 8c and discharged from the sample discharge line 22.

FIGS. 2F and 2G show the first sample chamber 8a filled with elution buffer liquid 32. The elution buffer liquid 32 separates the target molecules 13 from the magnetic particles 12 and transfers them into solution in the elution buffer liquid 32. The magnetic particles 12 remain magnetically fixed by the magnetic field 10 of the magnetic field generating means 9.

By transferring the elution buffer liquid 32 with the magnetic particles 12 and target molecules 13 contained therein from the first sample chamber 8a to the second sample chamber 8b and back into the first sample chamber 8a, this debonding of the target molecules 13 from the magnetic particles 12 by a turbulence and/or mixing during transfer is improved. The elastic membrane 4 is thereby displaced in the first cavity 5a such that the magnetic particles 12 are removed from the magnetic field-generating means 9, thereby removing the magnetic fixation.

In the state depicted in FIG. 2I, the target molecules 13 are in solution in the elution buffer liquid 32 in the first sample chamber 8a and the magnetic particles 12 are magnetically fixed again in the magnetic field 10 of the magnetic field generating means 9.

In a subsequent, non-illustrated step, elution buffer liquid 32 with the dissolved target molecules 13 may be discharged from first sample chamber 8a for further processing. To this end, further elution buffer liquid 32 is transferred from the second sample chamber 8b to the first sample chamber 8a and the elution buffer liquid 32 is transferred with the dissolved target molecules 13 from the first sample chamber 8a to the third sample chamber 8c. The magnetic particles 12 remain magnetically fixed in the first cavity 5a in the first sample chamber 8a by means of the magnetic field 10 of the magnetic field-generating means 9, such that they remain in the sample chamber 8a of the first cavity 5a upon discharge of the elution buffer liquid 32 with the dissolved target molecules 13. The target molecules 13 are separated from the impurities 14 and the magnetic particles 12.

1. A chip laboratory cartridge for a modular medical analysis system, comprising:
a layer structure including a pneumatic layer and a fluidic layer arranged in an extension plane and separated by a first elastic membrane,
wherein the pneumatic layer and the fluidic layer form a first cavity
wherein a first part of the first cavity is in the pneumatic layer and a second part of the first cavity is in the fluidic layer,
wherein a first sample chamber, bounded by the first elastic membrane, is formed in the first cavity,
wherein the first sample chamber is connected in a fluid-conducting manner to a first fluid channel and a second fluid channel formed in the fluidic layer,
wherein a liquid is introduced into the first sample chamber through the first fluid channel and/or the second fluid channel, and
wherein the pneumatic layer has a pneumatic channel through which the first part of the first cavity is exposed to a negative pressure or positive pressure, such that (i) the first elastic membrane is variably displaced in the first cavity and (ii) a volume of the first sample chamber is variably adjusted between a minimum volume and maximum volume; and
a magnetic field generator arranged in the chip laboratory cartridge, the magnetic field generator configured to generate a magnetic field acting in the first cavity, a magnetic field strength of the magnetic field is based on magnetic particles introduced into the first sample chamber through the first fluid channel and/or the second fluid channel or contained in the first sample chamber, such that (i) the magnetic particles are magnetically fixed by magnetic fixation after a fastening limit deformation of the first elastic membrane in a region of the first part of the first cavity is exceeded, and (ii) the magnetic fixation is released by moving the first elastic membrane in a direction of the second part of the first cavity after a release limit deformation of the first elastic membrane is undershot.

2. The chip laboratory cartridge according to claim 1, wherein the magnetic field generator comprises a permanent magnet having a volume from 0.3 to 8 mm3,

3. The chip laboratory cartridge according to claim 1, wherein the magnetic field generator comprises an electromagnet with which the magnetic field of variable magnetic field strength is generated.

4. The chip laboratory cartridge according to claim 1, wherein:
the fluidic layer is arranged above the pneumatic layer, and
the magnetic field of the magnetic field generator acts in the first cavity, such that the magnetic particles suspended in the first sample chamber sink under an influence of gravity in a direction of the first part of the first cavity into an area of action of the magnetic field of the magnetic field generator

5. The chip laboratory cartridge according to claim 1, wherein:
a second cavity having a second sample chamber is formed in the chip laboratory cartridge,
a third cavity having a third sample chamber is formed in the chip laboratory lab cartridge,
the first sample chamber is fluidly conductively connected to (i) the second sample chamber through the first fluid channel, and (ii) the third sample chamber through the second fluid channel, such that a series circuit connected in a fluid-conducting manner is formed from the first sample chamber, the second sample chamber, and the third sample chamber,
a sample supply line is connected in a fluid-conducting manner to the second sample chamber,
a sample discharge line is connected in a fluid-conducting manner to the third sample chamber,
a liquid is introduced into the second sample chamber through the sample supply line,
the liquid is transferred into the first sample chamber and further into the third sample chamber, and
the first part of the first cavity is pneumatically connected to a first pneumatic channel configured to act on the first elastic membrane, a first part of the second cavity is pneumatically connected to a second pneumatic channel configured to act on a second elastic membrane, and a first part of the third cavity is pneumatically connected to a third pneumatic channel configured to act, on a third elastic membrane such that a suction and/or pressure effect is generated in the first sample chamber, by a displacement of the first elastic membrane, the second elastic membrane, and the third elastic membrane, which causes the transfer of the liquid.

6. A system for performing an analysis, comprising:
at least one reaction mixture; and
a chip laboratory cartridge, according to claim 1, having an inlet for the at least one reaction mixture,
wherein the magnetic particles in the chip laboratory cartridge are upstream of or are surrounded by the at least one reaction mixture in the first sample chamber, and
wherein the first sample chamber is connected in a fluid-conducting manner to the inlet for the at least one reaction mixture.

7. A method for operating a chip laboratory cartridge having a layer structure with a pneumatic layer and a fluidic layer arranged in an extension plane and are separated by a first elastic membrane the pneumatic layer and the fluidic layer form a first cavity having a first part in the pneumatic layer and in a second part in the fluidic layer, a first sample chamber is bounded by the first elastic membrane and is formed in the first cavity the first cavity is connected in a fluid-conducting manner to a first fluid channel formed in the fluidic layer and a second fluid channel formed in the fluidic layer, a liquid is introduced into the first sample chamber through the first fluid channel or the second fluid channel, the pneumatic layer has a pneumatic channel through which the first part of the first cavity is exposed to a negative pressure or positive pressure, such that (i) the first elastic membrane is variably displaced in the first cavity, and (ii) a volume of the first sample chamber is variably adjusted between a minimum volume and maximum volume, the method comprising:
magnetically fixing magnetic particles by magnetic fixation after a fastening limit deformation of the first elastic membrane in a region of the first part of the first cavity is exceeded; and
releasing the magnetic fixation of the magnetic particles by moving the first elastic membrane in a direction of the second part of the first cavity after a release limit deformation of the first elastic membrane is undershot,
wherein a magnetic field generator is arranged in the chip laboratory cartridge and is configured to generate a magnetic field,
wherein the magnetic field acts in the first cavity,
wherein a magnetic field strength of the magnetic field is determined based on the magnetic particles (i) introduced into the first sample chamber through via the first fluid channel or the second fluid channel, or (ii) contained in the first sample chamber, and
wherein the fastening limit deformation and the release limit deformation is defined based on the magnetic field strength.

8. The method for operating a chip laboratory cartridge according to claim 7, further comprising:
introducing the liquid into a second sample chamber through a sample supply line;
transferring the liquid to the first sample chamber and further to a third sample chamber,
wherein a second cavity having the second sample chamber and a third cavity having the third sample chamber are formed in the chip laboratory cartridge,
wherein the first sample chamber is connected in a fluid-conducting manner to the second sample chamber through the first fluid channel and to the third sample chamber through the second fluid channel such that a series circuit connected in a fluid-conducting manner is formed from the first sample chamber, the second sample chamber, and the third sample chamber,
wherein the sample supply line is connected in a fluid-conducting manner to the second sample chamber and a sample discharge line is connected in a fluid-conducting manner to the third sample chamber, and
wherein the first part of the first cavity is pneumatically connected to a first pneumatic channel configured to act on the first elastic membrane, a first part of the second cavity is pneumatically connected to a second pneumatic channel configured to act on a second elastic membrane, and a first part of the third cavity is pneumatically connected to a third pneumatic channel configured to act on a third elastic membrane, such that a suction and/or pressure effect is generated in the first sample chamber by a displacement of the first elastic membrane, the second elastic membrane, and the third elastic membrane which causes the transfer of the liquid.

9. The method for operating a chip laboratory tab cartridge according to claim 8, wherein:
in the first sample chamber, the first elastic membrane is displaced such that the first sample chamber occupies a predominant part of the first part of the first cavity and is flowed through by the first fluid channel and the second fluid channel with a wash buffer liquid, and
the magnetic particles remain fixed in the first sample chamber by the magnetic field of the magnetic field generator during the flow through of the wash buffer liquid.

10. The method for operating a chip laboratory cartridge according to claim 9, further comprising:
introducing an elution buffer liquid into the first sample chamber through which target molecules adhered to the magnetic particles are detached from the magnetic particles and transferred into a solution.

11. The method for operating a chip laboratory lab cartridge according to claim 10, further comprising:
discharging the elution buffer liquid with the target molecules detached therefrom from the first sample chamber,
wherein the magnetic particles remain in the first sample chamber.
